(19) United States
(12) Patent Application Publication
(10) Pub. No.: US 2006/0071958 A1
(43) Pub. Date: Apr. 6, 2006

(54) Pen alignment method and device for printing apparatus

(75) Inventor: Kyoung-jae Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/238,971

(22) Filed: Sep. 30, 2005

(30) Foreign Application Priority Data
Oct. 2, 2004 (KR) 10-2004-0078550

(51) Int. Cl. B41J 2/195

(52) U.S. Cl. 347/7

(57) ABSTRACT

A pen alignment method and apparatus used in a printing apparatus, which perform a pen alignment operation when the amount of ink contained in an ink cartridge of an inkjet printing apparatus is reduced to a predetermined value or less. The pen alignment method includes measuring the amount of ink contained in an ink cartridge; determining whether the measured amount of ink is less than a predetermined value; and performing a pen alignment operation if the measured amount of ink is less than the predetermined value.

### CROSS-REFERENCE TO RELATED APPLICATION

This application claims the benefit of Korean Patent Application No. 2004-78550, filed on Oct. 2, 2004, in the Korean Intellectual Property Office, the disclosure of which is incorporated herein in its entirety by reference.

### BACKGROUND OF THE INVENTION

1. Field of the Invention

The present invention relates to a pen alignment method and apparatus used in a printing apparatus and, more particularly, to a pen alignment method and apparatus used in a printing apparatus, which perform a pen alignment operation when the amount of ink in an ink cartridge of an inkjet printing apparatus is reduced to a predetermined value or lower.

2. Description of the Related Art

In general, inkjet printing apparatus, such as inkjet printers or inkjet multifunctional devices, print data by ejecting ink contained in an ink cartridge onto a sheet of paper via nozzles. U.S. Pat. No. 6,106,108 discloses an inkjet printer, which measures the amount of ink remaining in an ink cartridge.

In the case of printing data using an inkjet printing apparatus, the quality of printing can be considerably enhanced by performing a pen alignment operation whenever an ink cartridge of the inkjet printing apparatus is replaced with another ink cartridge.

A pen alignment error may occur in an inkjet printing apparatus for various reasons. One of the various reasons is the variation of the amount of ink contained in an ink cartridge.

For example, during a print operation, the amount of ink contained in the ink cartridge decreases, and the weight of the ink cartridge containing the ink also decreases. However, a motor drives the ink cartridge with uniform power. As a result, a pen alignment error occurs in the inkjet printing apparatus.

In addition, in order to eject ink to wherever it should be ejected, a desired amount of ink should be supplied from an ink storage in the ink cartridge to nozzles of a printhead. However, as the amount of ink contained in the ink cartridge decreases due to the usage of ink, the pressure in the ink storage decreases, in which case, ink may be undersupplied from the ink storage to the nozzles of the printhead resulting in a pen alignment error.

Even if pen alignment error occurs, the quality of printing still can be enhanced by notifying a user of the inkjet printing apparatus that a pen alignment operation needs to be performed or by enabling the pen alignment operation to be automatically performed. However, in the prior art, when pen alignment error occurs, a better printing quality cannot be obtained since a user has not been notified of the fact that a pen alignment operation needs to be performed, or no pen alignment operation has been automatically performed. Therefore, the user has no other option but to use the inkjet printing apparatus, regardless of whether the inkjet printing apparatus needs to undergo a pen alignment operation, until he/she replaces the ink cartridge of the inkjet printing apparatus with another ink cartridge and then performs a pen alignment operation.

### SUMMARY OF THE INVENTION

Additional aspects and/or advantages of the invention will be set forth in part in the description which follows and, in part, will be apparent from the description, or may be learned by practice of the invention.

The present invention provides a pen alignment method used in a printing apparatus, which performs a pen alignment operation when the amount of ink contained in an ink cartridge in an inkjet printing apparatus is reduced to a predetermined value or lower.

The present invention also provides a pen alignment device used in a printing apparatus, which performs a pen a alignment operation when the amount of ink contained in an ink cartridge in an inkjet printing apparatus is reduced to be a predetermined value or lower.

According to an aspect of the present invention, there is provided a pen alignment method used in a printing apparatus that uses ink. The pen alignment method includes measuring the amount of ink contained in an ink cartridge; determining whether the measured amount of ink is less than a predetermined value; and performing a pen alignment operation if the measured amount of ink is less than the predetermined value.

According to another aspect of the present invention, there is provided a pen alignment device used in a printing apparatus that uses ink. The pen alignment device includes: a measurement unit, which measures the amount of ink contained in an ink cartridge; a determination unit, which determines whether the measured amount of ink is less than a predetermined value; and a pen alignment unit, which performs a pen alignment operation if the measured amount of ink is less than the predetermined value.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a pen alignment method according to an exemplary embodiment of the present invention;

FIG. 2 is a block diagram of a pen alignment device according to an exemplary embodiment of the present invention;

FIG. 3 is a graph illustrating a desired operating state of a carriage; and

FIG. 4 is a graph showing differences between an actual operating state of a carriage when an ink cartridge is full of ink and an actual operating state of the carriage when the ink cartridge is not full of ink.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention will now be described more fully with reference to the accompanying drawings, in which exemplary embodiments of the invention are shown.

FIG. 1 is a flowchart of a pen alignment method according to an embodiment of the present invention. Referring to FIG. 1, in operation S10, the amount of ink contained in an ink cartridge is determined. In operation S20, it is determined whether the measured amount of ink is less than a predetermined value. In operation S30, if the measured amount of ink is less than the predetermined value, a pen alignment operation is performed.

In operation S10, the amount of ink remaining in the ink cartridge may be determined by measuring the amount of ink used for printing.

The predetermined value denotes the amount of ink remaining in the ink cartridge at the moment when a pen alignment error occurs. A pen alignment error may occur for one of the following reasons. First, as the weight of the ink cartridge containing ink decreases due to the consumption of ink for printing, a motor is likely to fail to normally drive a carriage having the ink cartridge, which results in a pen alignment error. Second, as the pressure inside the ink cartridge decreases due to the consumption of ink for printing, ink is unlikely to be normally supplied to nozzles of a printhead, which results in a pen alignment error.

In operation S30, a message indicating that a pen alignment operation needs to be performed may be displayed to a user. A printing apparatus may automatically perform a pen alignment operation while printing test patterns on a paper. In other words, if the user checks the message indicating that a pen alignment operation needs to be performed and then commands the printing apparatus to print the test patterns on the paper, the printing apparatus automatically performs a pen alignment operation while printing the test patterns on the paper.

Alternatively, in operation S30, if the amount of ink remaining in the ink cartridge is reduced to the predetermined value or lower, a pen alignment operation may be automatically performed. In other words, if the amount of ink remaining in the ink cartridge is reduced to the predetermined value or lower, the printing apparatus is set to automatically print test patterns on the paper. The printing apparatus automatically performs the pen alignment operation while printing the test patterns on the paper.

In general, a pen alignment method is classified into either a manual pen alignment method or an automatic pen alignment method.

In a manual pen alignment method, a user checks paper on which test patterns are printed and then manually sets pen alignment information. Conventionally, a user properly aligns an ink cartridge using the manual pen alignment method. In order to properly align the ink cartridge in the manual pen alignment method, a predetermined pen alignment program is executed with the use of a computer so that test patterns are printed on a paper. Thereafter, the user checks the test patterns printed on the paper, selects one of the test patterns that most resembles a straight line, and this sets pen alignment information used for printing the selected test pattern in a printing apparatus using the pen alignment program. Then, the printing apparatus may perform a pen alignment operation later on with reference to the pen alignment information set therein before printing data received from a computer. The manual pen alignment method, however, has the following disadvantages. First, it is inconvenient for the user to check each of the test patterns printed on the paper. Second, it is also inconvenient for the user to manually set in the printing apparatus the pen alignment information used for printing one of the test patterns that resembles a straight line most.

Therefore, an automatic pen alignment method has become more popular these days than the manual pen alignment method. In the automatic pen alignment method, a printing apparatus automatically sets pen alignment information while scanning paper on which test patterns are printed. In other words, when a user commands the printing apparatus to print the test patterns, the printing apparatus prints the test patterns on paper under various pen alignment conditions, reads the test patterns from the paper with the use of a scanner, compares the read test patterns with reference patterns, and searches for and sets one of the various pen alignment conditions that is most optimal for an ink cartridge based on the comparison results. Therefore, the user does not have to check each of the test patterns printed on the paper or does not have to manually set the pen alignment condition determined most optimal for the ink cartridge in the printing apparatus. The automatic pen alignment method is used in an aspect of the present invention.

The printing apparatus may be an inkjet printer or an inkjet multifunctional device, into which at least one of an inkjet printer, a scanner, a photocopier, and a facsimile is integrated.

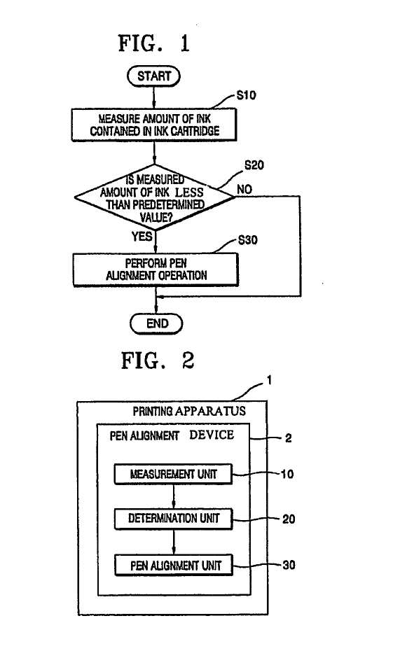

FIG. 2 is a block diagram of a pen alignment device 2 according to an embodiment of the present invention. Referring to FIG. 2, the pen alignment device 2 includes a measurement unit 10, a determination unit 20, and a pen alignment unit 30. According to an aspect of the present invention, the pen alignment device 2 is included in a printing apparatus 1. The printing apparatus 1 may be an inkjet printer or an inkjet multifunctional device.

The measurement unit 10 measures the amount of ink contained in an ink cartridge. The determination unit 20 determines whether the measured amount of ink is less than a predetermined value. The pen alignment unit 30 performs a pen alignment operation if the measured amount of ink is less than the predetermined value.

The measurement unit 10 may measure the amount of ink remaining in the ink cartridge by measuring the amount of ink used for printing.

According to an aspect of the present invention, the predetermined value denotes the amount of ink remaining in the ink cartridge at the moment when a pen alignment error occurs. A pen alignment error may occur for one of the following reasons. First, as the weight of the ink cartridge containing ink decreases due to the consumption of ink for printing, a motor is likely to fail to normally drive a carriage having the ink cartridge, which results in a pen alignment error. Second, as the pressure inside the ink cartridge decreases due to the consumption of ink for printing, ink is unlikely to be normally supplied to nozzles of a printhead, which results in a pen alignment error.

The pen alignment unit 30 may display a message indicating that a pen alignment operation needs to be performed to a user. Alternatively, if the measured amount of ink is less than the predetermined value, the pen alignment unit 30 may be set to automatically perform a pen alignment operation. The pen alignment unit 30 may automatically perform a pen alignment operation while printing test patterns on a paper.

In general, in a case where the user replaces an ink cartridge (not shown) of the printing apparatus 1 with another ink cartridge, the pen alignment unit 3 may display the message indicating that a pen alignment operation needs to be performed on a display unit (not shown) of the printing apparatus 1, such as a liquid crystal display (LCD). The pen alignment unit 3 may send the message to a display device connected to the printing apparatus.

When the printing apparatus 1 performs a printing operation, ink contained in the ink cartridge is consumed. If the amount of ink remaining in the ink cartridge is reduced to a predetermined value or less, a pen alignment error occurs adversely affecting the quality of printing. In this case, the quality of printing can be considerably enhanced by performing a pen alignment operation.

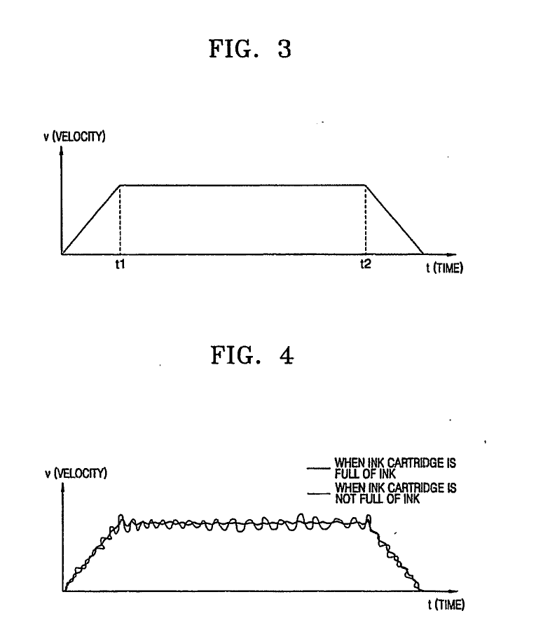

Examples of an occasion when a pen alignment operation needs to be performed will be described in the following with reference to FIGS. 3 and 4. FIG. 3 is a graph showing a desired operating state of a carriage, and FIG. 4 is a graph showing differences between an actual operating state of a carriage when an ink cartridge is full of ink and an actual operating state of the carriage when the ink cartridge is not full of ink.

Specifically, FIG. 3 illustrates how a motor drives a carriage having an ink cartridge under desired conditions. Referring to FIG. 3, a horizontal axis represents time, and a vertical axis represents the velocity of the carriage. During a period between t1 and t2, the motor desirably drives the carriage so that the carriage moves at a uniform velocity.

In the real world, however, the carriage does not move at the uniform velocity. In other words, actual velocity of the carriage is likely to deviate from desired velocity of the carriage, and thus an error between the actual velocity and desired velocity of the carriage should be constantly corrected. Accordingly, as shown in FIG. 4, the actual velocity of the carriage varies describing ripples.

In general, the motor is controlled to drive the carriage on the assumption that the ink cartridge is full of ink. Therefore, the variation of the velocity of the carriage describes small ripples if the ink cartridge is full of ink. However, if the weight of the carriage is reduced due to the consumption of ink contained in the ink cartridge, the variation of the velocity of the carriage describes larger ripples. In short, the decrease in the weight of the carriage causes the velocity of the carriage to vary, and the variation of the velocity of the carriage adversely affects an aligned state of data printed on paper by the printing apparatus 1 (hereinafter referred to as pen alignment of the printing apparatus 1).

There exists an error range in which the motor can be controlled without adversely affecting the pen alignment of the printing apparatus 1. However, if the amount of ink contained in the ink cartridge is reduced so that an error between the actual velocity and desired velocity of the carriage becomes outside the error range, the motor cannot be controlled any longer without adversely affecting the pen alignment of the printing apparatus 1. Accordingly, the amount of ink remaining in the ink cartridge when the error between the actual velocity and desired velocity of the carriage starts to become outside the error range is set as the predetermined value. The predetermined value is stored in a non-volatile random access memory (NVRAM). The predetermined value may vary depending on the types of an engine and the ink cartridge of the printing apparatus 1. Thus, the predetermined value is experimentally determined and then stored in the NVRAM.

If the amount of ink remaining in the ink cartridge is reduced to be less than the predetermined value, the printing apparatus 1 may display the message indicating that a pen alignment operation needs to be performed to the user or may be set to automatically perform a pen alignment operation while printing test patterns on a paper. Therefore, the printing apparatus 1 can achieve an optimum quality of printing.

Another method of determining the predetermined value will be described in the following. In general, ink is supplied from an ink storage in the ink cartridge to nozzles of a printhead and then is ejected. However, as pressure inside the ink cartridge gradually decreases due to the consumption of ink for printing, ink may be undersupplied from the ink storage to the nozzles of the printhead. In particular, if ink is undersupplied from the ink storage to the nozzles of the printhead, a direction in which ink droplets are ejected from the nozzles onto a paper may undesirably change, and thus, the distance the ink droplets moved may also change. As a result, a pen alignment error may occur. Therefore, in order to supply an exact amount of ink needed to the nozzles of the printhead, only a minimum level of pressure is required. Therefore, the amount of ink remaining in the ink cartridge at the moment when the pressure in the ink cartridge begins to be lower than a critical value is determined as the predetermined value, and then the predetermined value is stored in the NVRAM. The predetermined value may be experimentally determined in advance.

If the amount of ink remaining in the ink cartridge is reduced to be less than the predetermined value, the printing apparatus 1 may display the message indicating that a pen alignment operation needs to be performed to the user or may be set to automatically perform a pen alignment operation while printing test patterns on a paper. Therefore, the printing apparatus 1 can achieve an optimum quality of printing.

As described above, in the present invention, a pen alignment operation is automatically performed when the amount of ink contained in the ink cartridge is reduced to be less than a predetermined value. Accordingly, it is possible to compensate for a pen alignment error caused by a decrease in the amount of ink contained in the ink cartridge and achieve an optimum quality of printing.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A pen alignment method used in a printing apparatus that uses ink, the pen alignment method comprising:
measuring an amount of ink contained in an ink cartridge;
determining whether the measured amount of ink is less than a predetermined value; and
performing a pen alignment operation if the measured amount of ink is less than the predetermined value.

2. The pen alignment method of claim 1, wherein the amount of ink contained in the ink cartridge is measured by measuring an amount of ink used for printing.

3. The pen alignment method of claim 1, wherein the amount of ink remaining in the ink cartridge when a pen alignment errors occurs is determined as the predetermined value, wherein the pen alignment errors occurs when a motor fails to normally drive a carriage having the ink cartridge due to a decrease in a weight of the ink cartridge.

4. The pen alignment method of claim 1, wherein the amount of ink remaining in the ink cartridge when a pen alignment errors occurs is determined as the predetermined value, wherein the pen alignment errors occurs when ink is undersupplied from the ink cartridge to nozzles of a printhead due to a decrease in pressure inside the ink cartridge.

5. The pen alignment method of claim 1, wherein if the measured amount of ink is less than the predetermined value, a message indicating that a pen alignment operation needs to be performed is displayed to a user, and/or a pen alignment operation is automatically performed.

6. The pen alignment method of claim 1, further comprising:
sending a message indicating the measured amount of ink to a display device.

7. A pen alignment device used in a printing apparatus that uses ink, the pen alignment device comprising:
a measurement unit, which measures an amount of ink contained in an ink cartridge;
a determination unit, which determines whether the measured amount of ink is less than a predetermined value; and
a pen alignment unit, which performs a pen alignment operation if the measured amount of ink is less than the predetermined value.

8. The pen alignment device of claim 7, wherein the measurement unit measures the amount of ink contained in the ink cartridge by measuring an amount of ink used for printing.

9. The pen alignment device of claim 7, wherein the amount of ink remaining in the ink cartridge when a pen alignment errors occurs is determined as the predetermined value, wherein the pen alignment errors occurs when a motor fails to normally drive a carriage having the ink cartridge due to a decrease in a weight of the ink cartridge.

10. The pen alignment device of claim 7, wherein the amount of ink remaining in the ink cartridge when a pen alignment errors occurs is determined as the predetermined value, wherein the pen alignment errors occurs when ink is undersupplied from the ink cartridge to nozzles of a printhead due to a decrease in pressure inside the ink cartridge.

11. The pen alignment device of claim 7, wherein the pen alignment unit displays a message indicating that a pen alignment operation needs to be performed to a user and/or automatically performs a pen alignment operation if the measured amount of ink is less than the predetermined value.

12. The pen alignment device of claim 7, wherein the predetermined value is stored in a non-volatile random access memory (NVRAM).

13. A pen alignment method used in a printing apparatus that uses ink, the pen alignment method comprising:
measuring an amount of ink contained in an ink cartridge; and
displaying the measured amount of ink on a display device.

14. The pen alignment method of claim 13, further comprising:
performing a pen alignment operation responsive to a user input.

15. A pen alignment method for a printing apparatus, the pen alignment method comprising:
measuring an amount of ink contained in an ink cartridge; and
sending the measured amount of ink contained in the ink cartridge.

16. The pen alignment method of claim 15, further comprising:
receiving a command to perform a pen alignment operation; and
performing the pen alignment operation.

17. A pen alignment system for a printing apparatus, comprising:
a measurement unit to measure an amount of ink contained in an ink cartridge;
an input receiving unit to receive a user input to perform a pen alignment; and
a pen alignment unit to perform the pen alignment based upon the user input.

18. The printing apparatus of claim 17, further comprising:
a display unit to display the measured amount of ink.
